(19) United States
(12) Patent Application Publication
(10) Pub. No.: US 2002/0029133 A1
(43) Pub. Date: Mar. 7, 2002

(54) Method and a computer graphics system for designing an entire area of a subway station

(76) Inventor: Sumiko Imai, Tokyo (JP)

Correspondence Address: KODA & ANDROLIA, SUITE 3850, 2029 Century Park East, Los Angeles, CA, 90067-3024, US

(21) Appl. No.: 09/870,283

(22) Filed: May 30, 2001

(30) Foreign Application Priority Data
Sep. 6, 2000 (JP) 2000-270709

(51) Int. Cl. G06F 17/50

(52) U.S. Cl. 703/1

(57) ABSTRACT

A computer graphics system for designing on a unified concept the entire area of a subway station, including the passage extending from the subway entrance connecting the ground-level public street to the station platform. The computer graphics system comprising: designing the entire station, including the wall, floor and ceiling of a passage, floors, valleys between escalators, the wall, step and ceiling of an escalator, the wall of a platform, tunnels (portions extending about 100 meters into the tunnel from the ends of a platform), pillars, floors and the like on a unified concept using computer graphics; registering various created designs in a database as components; and pasting the components together on a specified location as needed in order to design the entire area of a subway station.

### BACKGROUND OF THE INVENTION

1. Field of the Invention

The present invention relates to a design method to achieve higher advertising effect by designing an entire subway station, extending from the entrances via underground passages to the platforms, in a unified manner and to provide a design that can offer direct effects, such as with a sign, and simultaneously render the subway platforms and underground passages (within the entire area of a station) a pleasant environment for the user; and further, that pertains to a computer graphics process and system for efficient implementation and operation of the design method.

2. Prior Art

The routes to subway stations currently function only as passages. Needless to say, major walls carry advertisements, but there is no total advertisement in which the entire area of a subway station is on exclusive contract with one advertiser (sponsor). No underground passages or platforms are designed along the lines of a particular concept but on whatever happens to suit the occasion. There is no denying that the passages give an impression that they are simply pathways for users.

The impression may be attributable to the lack of a unified concept applied to the design of the entire passage, extending from the ground-level entrance and underground passage to the subway station platform. The reason for this is the absence of an advertising system whereby the entire station (not only the platform but also the surrounding area between the ground-level underground entrance and the platform) is under an exclusive contract.

Contrastingly, in the field of computer graphics various kinds of software are being developed. Especially in the design field, PhotoShop, Illustrator and other design software are used extensively. The application of these programs allows the efficient storage of handwritten designs and photographs, the creation of designs directly on a computer and the modification of previously stored designs. The added capability of printing designs directly out of a computer has made the design programs indispensable in the design field.

As explained under the prior art, the main function of a subway station and its passage is to enable passengers or pedestrians to utilize subway trains rather than to offer a comfortable space. Advertisements are paper posters and slide-glass type panels. Many of them are single advertisements (that is, advertisements that possess no storytelling continuity). The walls of the passages and platforms show the tiles exposed, and more often than not also show stains from water leakage.

The economy may be named as one cause of the phenomena. Being very much of public service, a subway system-which depends on user fares for most of its revenue-is unable to raise its fares inordinately and spend much money on the beautification of passages and platforms. Advertisements, which are limited in volume, produce no amounts that can be spared for underground beautification. The advertisers of today, among others, have no small doubts about the effectiveness of advertising in subway stations, and certainly expect no level of effectiveness comparable to advertising on television and in newspapers.

The underground passage and subway platform simply function as a means for pedestrians to pass through or passengers to utilize a subway train. They are dull spaces for users. It is observed that homeless persons and purposeless youths gather in dark or dirty spots. The fact that they loiter in subway stations proves that underground passages have become exactly the place for such gatherings.

### SUMMARY OF THE INVENTION

The object of the present invention is to provide a design method and a computer system that serves the purposes of and efficiently carry out the improvement in the advertising effectiveness through integrated advertising in the entire area (the area extending from the ground-level entrance to the underground passage all the way to the station platform) by one advertiser, and the beautification of the entire advertised area at the same time.

In the present invention, the means of solving the above-described problems is to allow the entire area of the subway premises to be integrally advertised by one advertiser, thus simultaneously achieving the objectives of effective advertising and beautification of the underground area. An advertisement may also be designed in such a way that it would serve as a direction sign or guide marker in case of a power outage. An explanation follows concerning a method of designing to satisfy the above-described objectives and a computer system that implements the method efficiently.

The computer system of the preset invention is for designing on a unified concept the entire area of a subway station, including the passage extending from the subway entrance connecting the ground-level public street to the station platform; and the computer system comprises: designing the entire station, including the wall, floor and ceiling of a passage, floors, valleys between escalators, the wall, step and ceiling of an escalator, the wall of a platform, tunnels (portions extending about 100 meters into the tunnel from the ends of a platform), pillars, floors and the like on a unified concept using computer graphics; registering various created designs in a database as components; and pasting the components together on a specified location as needed in order to design the entire area of a subway station.

In other words, the new method of the present invention, unlike the prior art spot advertisements and decorations, is to design the decor for the entire walls of the underground passages and station. Moreover, the entire area to be designed has a unified concept. The design is carried out using computer graphics. The computer system shall be a system that allows the storage, reuse, printing of wallpaper (the wrapping sheets used in the present invention) and the like.

The created designs shall be stored as components (design data) in a database. The unit of design need not necessarily be uniform but may be of a convenient size for design purposes, a meaningful chain (for example, the length of a station platform or the height of a tunnel), or wrapping sheets with an adhesive on the back surface for mounting on the walls or floors in the area, and others. Design components (design data) are sent to a printing plant for printing out on adhesive-backed wrapping sheets and are cut into sizes that are easy to handle. If a component is set up in a convenient adhesive size at the design stage, wrapping sheets may be printed in the unit of that component.

In the present invention the entire area of a subway station is designed through use of a unified concept. For example, if a platform is located on the third basement level, each of the first, second and third (platform) levels may be unified in design-for example, in the designs of skies, land and sea, respectively-thereby offering the user a comfortable underground space while helping identify the floor level simply through visual means. In the present invention particularly, the emphasis is placed on having one advertiser (normally, a single business or business group) advertise in one area (block) in order to fill the entire area with the advertisements of that advertiser. Here, the scheme shall be to design the background and foreground separately, design the advertisements of the advertiser as components in the foreground, and paste up the foreground components on the background in a story-like layout, or in a repeated layout, in keeping with the flow of passengers from the entrance to the station platform.

The reason for designing the foreground and background (components) separately is that they facilitate the replacement of the advertisement design, which is a component, when there is a change in advertisers or a decision to change the advertised content. When a change is processed through the computer system, the simple replacement of a component (design data) allows the reuse of previous data, resulting in the efficient implementation of changes (that is, the replacement operation).

The simple replacement of data in the computer system still implies a need to replace the designs at the advertised site. An advertisement that is painted directly on a wall would only require covering the surface and redrawing the change. Since the present invention uses a wrapping sheet, which is a paper whose top surface is covered with a weather-resistant transparent sheet and whose back surface is coated with adhesive, the paper must be replaced for each design change. Accordingly, the background shall use a wrapping sheet with a strong adhesive while the foreground shall use a wrapping sheet with a removable adhesive.

The stairway or escalator is a place through which the users of an underground passage or subway train must certainly pass. Especially, the user of an escalator remains at a standstill (walking in some cases) with eyes unfixed. In the present invention advertisements are posted on a wall alongside an escalator, the space between a handrail belt of the escalator and wall, the space between two escalators, the steps at the entrance and exit to the escalator, and other areas around the escalator, none of which is currently used for advertising. In this case, an advertisement shall be designed to function not only as an advertisement but also as a direction sign (for which specific examples are given later). Light-storing pigment inks shall be used to print the advertisements so that the luminous advertisement would function as a direction sign during a power outage.

Advertisements printed with light-storing pigment inks are posted in dark areas in order to take the advantage of the glowing effect given off in response to incidental light. The idea is that an advertisement in light-storing pigment inks that glow upon absorption of the light from the headlight of a train will stand out as the train approaches, attracting the attention of passengers waiting on the platform or riding on the train. More specifically, the advertisement in this case is for an area extending from the tunnel entrance at the end of a platform to a point approximately 100 meters into the tunnel, or a block within a tunnel. The design and location of the advertisement in this case must be selected so that it causes no disturbance to the train operator. (It has been confirmed that an advertisement in light-storing pigments within approximately 100 meters of a platform would not cause the operator to mistake the same for the platform.)

Subway walls are often seen with stains caused by underground water seeping out of concrete walls. The staining may be prevented by the installation of a gutter. An exposed gutter is esthetically unattractive, adding to the blandness of subway premises. A picture shall be designed integrating the gutter in order to render the gutter itself inconspicuous, thereby obscuring stains in the subway interior and creating a comfortable underground space.

### BRIEF DESCRIPTION OF DRAWINGS

FIGS. 1(1) through 1(3) show the subway premises used to explain the present invention wherein FIG. 1 (1) is a view of the passage on a first basement level, FIG. 1(2) is a plan view of a subway station platform on a second basement level, and FIG. 1(3) shows a side elevation of the subway station premises;

FIG. 2 is a cross-sectional view of the wrapping sheet used in the present invention;

FIG. 3 is a flowchart describing a computer graphics system used to design the entire area of a station (subway premises) in terms of the input, output and the flow through the same in the present invention;

FIG. 4 shows blocks correlating the design block, which is the unit to be designed in the computer graphics system of the present invention, with the actual blocks in the subway station premises;

FIG. 5 shows the coding system by which different design blocks are coded (for the purpose of design identification) in the present invention;

FIG. 6 shows a construction of a database used in the computer graphics system of the present invention;

FIG. 7 shows a relationship of a design database with design blocks, components and small components;

FIG. 8 is a horizontal cross-sectional view of an escalator area for explaining the location of an escalator area to be designed in the present invention;

FIG. 9 is a horizontal cross-sectional view of an escalator area for explaining the location of an escalator area to be designed in the present invention;

FIG. 10 shows a spot advertisement placed on a passage and an example of such advertisement serving as a guide marker in the present invention;

FIG. 11 is an elevational view of an example of designing the entire area of a subway station on a unified concept in the present invention (corresponding to FIG. 1(1));

FIG. 12 shows an example of designing the ceiling over a platform track and the wall alongside the track in conformance with a unified concept in the present invention; and

FIG. 13 shows an example of designing the ceiling over a platform track and the wall alongside the track in conformance with a unified concept of the present invention.

### DETAILED DESCRIPTION OF THE INVENTION

The embodiments of the present invention will be described below with reference to accompanying drawings.

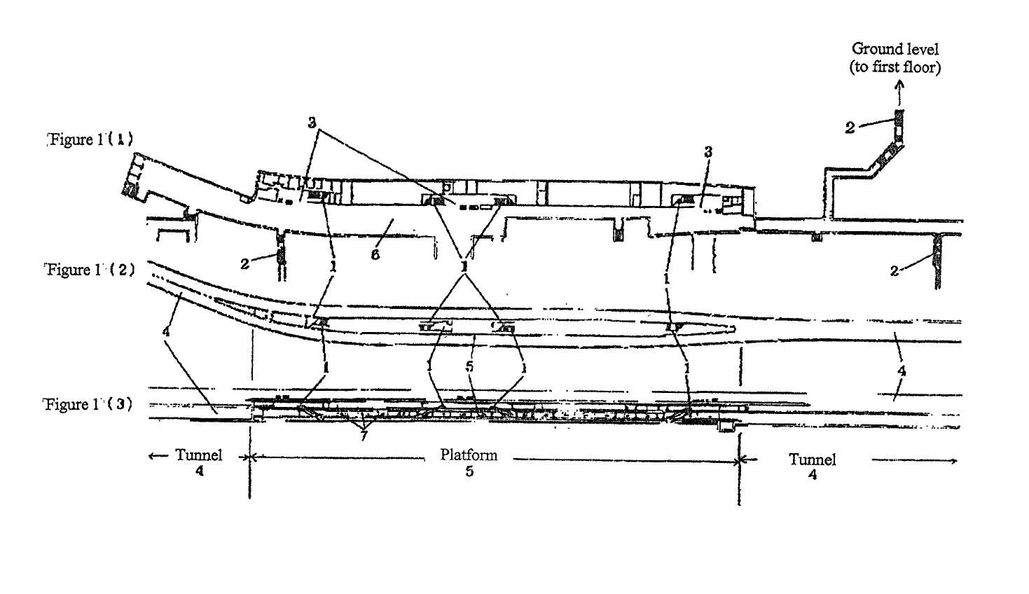

FIG. 1 shows an area that includes the subway platform. In the example given in the figure, the platform is on the second basement level, with ticket gate 3 on the first basement level. FIG. 1(1) shows a plan view of the passage area on the first basement level. FIGS. 1(2) and 1(3) show a plan view and side elevation, respectively, of the platform on the second basement level. Stairway 2 connects the ground level (the first floor in the case of a building) and the first basement level. The area of the present invention includes the entire area extending from the ground-level exit (entrance) of stairway 2 in the figure to the first basement level and second basement level (station platform). The walls, ceilings, floors, pillars, and the steps, walls and valleys of escalator 1, guard wall 7 and tunnel 4 (normally, the area extending approximately 100 meters into the tunnel from the end of the platform) are the objects to be designed through a unified concept under the present invention. In a normal computerized process, design is carried out in small units after dividing the entire structure into blocks, and by storing component data (design data) into a database.

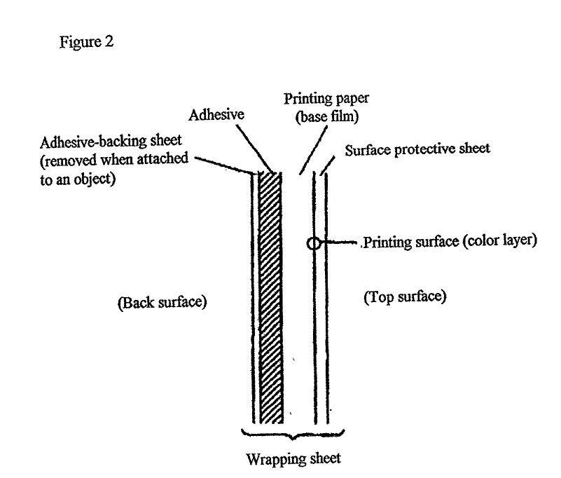

In the present invention, the created designs (component data) are not applied directly to the wall or floor (with the painting method not necessarily denied) but printed on a paper material. The paper material allows printing on the paper part (base film), wrapping the printed surface with a surface-protective sheet, applying an adhesive to the back side (opposite the printed side), attaching an adhesive-backing sheet thereto, and mounting the paper directly on a desired object on the job site following removal of the adhesive-backing sheet. The paper material is referred to as the “wrapping sheet.” Its basic construction is shown in FIG. 2. Examples of materials used for the base film include 90 μm olefin/EVA lamination and 50 μm polyurethane single sheet. The adhesive may be selected from either the compliant type or removable type to suit the purpose. Examples of the material for the surface-protective sheet include protective laminates of acrylic or PVC film with a fluoroplastic coating several μm thick. Various adhesives are available, depending on the adhesive power required, including long-term (permanent adhesion), medium-term (strong adhesive power) and short-term (removable) types. The background shall use the permanent adhesion or strong adhesive power types, whereas the foreground shall use a removable type.

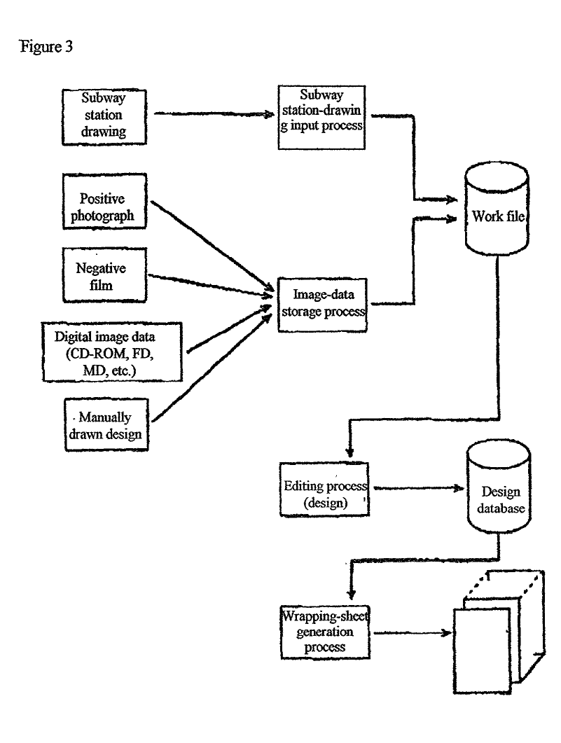

FIG. 3 shows a flow through the computer graphics system in a design process for the entire area of a subway station, in terms of input and output. First, the structure of the subway station is entered into the computer, based on a drawing (for example, FIG. 1). The dimensions shown in the drawing are also accurately entered at this time. The design proceeds in accordance with these dimensions to the point of determining the sizes of wrapping sheets needed. Next, images to be used in the design process are stored in digital form. Positive photographs and manually drawn designs, for example, are entered through an image scanner, digitized and stored in work files. If Illustrator is to be used in the editing process, it shall be used in combination with PhotoShop (to convert the image data entered through a scanner into an EPS file for use by Illustrator). If image data is to be provided via a digital camera or off-the-shelf CD-ROM, it will be accepted by Illustrators as input data.

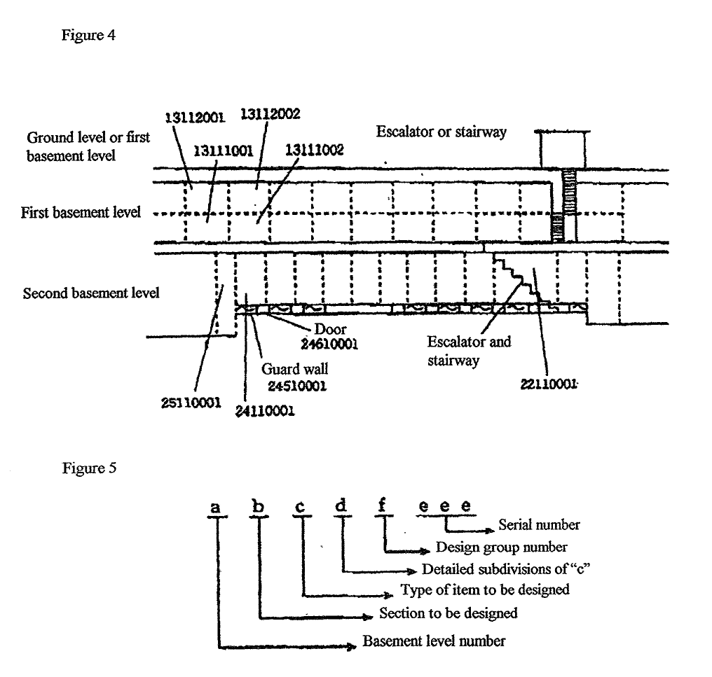

The subway station is divided into design units. FIG. 4 shows an example of such division, with each section (design block) coded. The code shall be referred to as the “design identification code.” Any coding method (for example, serial numbers) may be used, but a meaningful coding system would facilitate their identification. FIG. 5 shows an eight-digit coding system. FIG. 4 is an example of dividing a subway station and coding the divided sections using the coding system of FIG. 5. Codes “a” through “eee” have the following meanings:

a =n: Basement level number, with the “n” denoting the nth floor

b =1: Stairway

=2: Escalator

=3: Passage

=4: Platform of subway station

=5: Tunnel

c =1: Wall

=2: Ceiling

=3: Floor

=4: Valley by escalator

=5: Guard wall

=6: Door

d =n: The “n” is the identification number for subdivisions of “c.” For example, the right and left walls of a passage would be numbered “1” and “2,” respectively.

f =n: The “n” is the design group number within the block identified by “a” through “d,” and is normally identified with a serial number.

eee: A serial number within each of “a” through “f”

The coding method shall be explained using codes 13112001 and 13112002 as examples. The first five digits are the same values but the last three digits, as in 001 and 002, represent subdivisions within the same design group (a series of contiguous designs). The 001 and 002 may be the same or different designs. In either case, they are the smallest units to be processed in the design-editing process shown in FIG. 3. In any case, the coding system as shown shall be used to index a design to the object in the subway station to which that design is to be applied. The first five digits of 13121001 and 13121002 have the following meanings:

1: The first basement level

3: Passage

1: Wall

1: Right (the right wall)

2: Upper (the upper right wall)

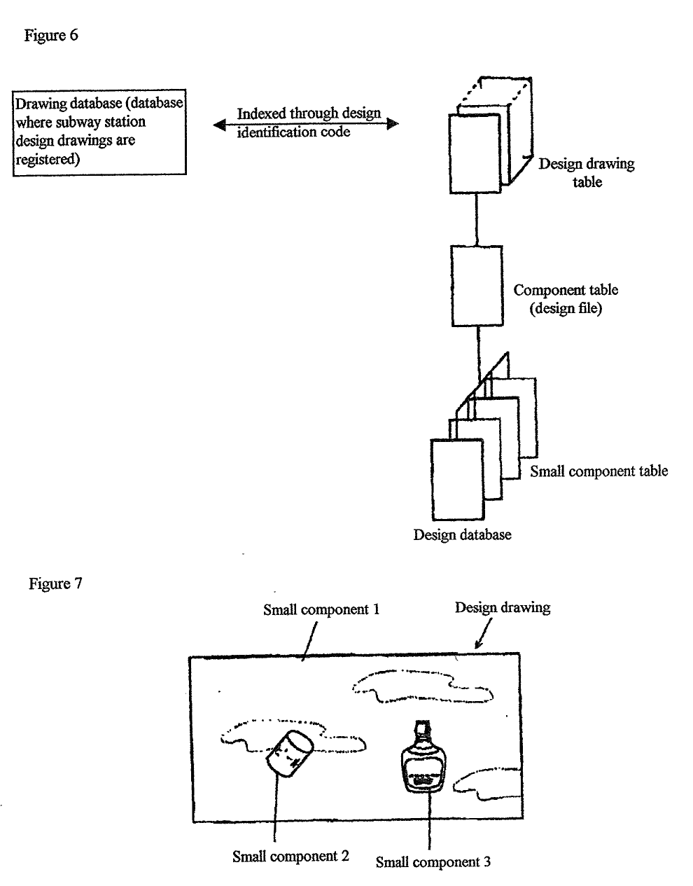

As explained in the above, the design block is the smallest unit to be processed in the design-editing process. A series of design blocks shall ultimately decorate the whole interior of the subway station. In this case, a design in one design block may very well be the same as a design in another design block. For example, as shown in FIG. 4, if the upper portion of the passage wall of the first basement level is entirely a repetition of 13112001, only 13112001 is designed. The design as 13112001 can be used in 13112002 through 1311200n. (If a sky were used in the design, a repetition of the same design would not look odd.) Accordingly, the upper part of the wall in the first-basement level passage would only need the design of 13112001, requiring only one kind of component data to be registered into a design database. The design database would then be structured as shown in FIG. 6. The term “component” refers to a design data that would decorate a design block. The figure shows that a component constitutes a combination of smaller components.

To explain the foregoing further, using FIG. 7 as an example, the design block is a composite of three small components. Small component 2 (a photograph of a can of beer) and small component 3 (a photograph of bottled water) are composed together over the background, which is small component 1 (a photograph of a sky), to form one component. Small components 2 and 3 are normally advertisements. Therefore, when the advertisements are changed in a future, the replacement of small components 2 and 3 will facilitate the required change in the design of the same design block. At any rate, where one design is repeatedly laid out, one component table and a multiple of design-block tables are linked in the database.

The size of a design block is preferably made equal to, but not necessarily required to be, the size of the printing material (wrapping sheet) for efficient preparation (refer to FIG. 3) of the wrapping sheet. A relatively wide design block can be selected given the use of 3 M Corporation's Scotch Printer 2000 System (maximum capacity, 1300 mm wide times a theoretically unlimited longitudinal length), which is a large xerographic full-color printer. In practice, the size may have to be somewhat limited to facilitate the transportation and application of wrapping sheets. Some work may be required on wrapping sheets where a design block is larger than the printable width or a wrapping sheet of printable width must be sliced down for convenience in installation. The sizing is outside the scope of the present invention and is left to the discretion of the installer. The designer shall still be required to prepare, at least to some extent, the instructions and description of the work for the benefit of the installer, and shall use the subway drawing database that includes the dimensions.

The important point in the present invention is to have one advertiser contract for the entire area of a subway station. There are two advertising formats: one is to advertise merchandise the advertiser wants to sell, and the other is to publicize a corporate image. If different businesses offer products of the same performance at similar prices, the consumer tends to select the product by a business having a better image. In television commercials, if a company sponsors an entire program, the company often advertises its corporate image rather than its products. In this kind of advertising an emphasis is placed on the presentation of a corporate history or demonstration of how greatly the corporation contributes to society. The present invention shall use this format, unlike the spot advertisements conventionally seen in subway stations, in order to induce one advertiser to contract exclusively. For example, a corporate image is publicized in the description of a history and contribution of a business to society by primarily using pictures and photographs along the flow of subway passengers. A hypothetical advertiser, in this case an automobile maker, may indirectly advertise its corporate history and image by laying out the company=3 s automobiles on the walls in chronological order, in accordance with the flow of subway users through stairways or escalators, starting with the ground-level entrance and extending to the subway platform.

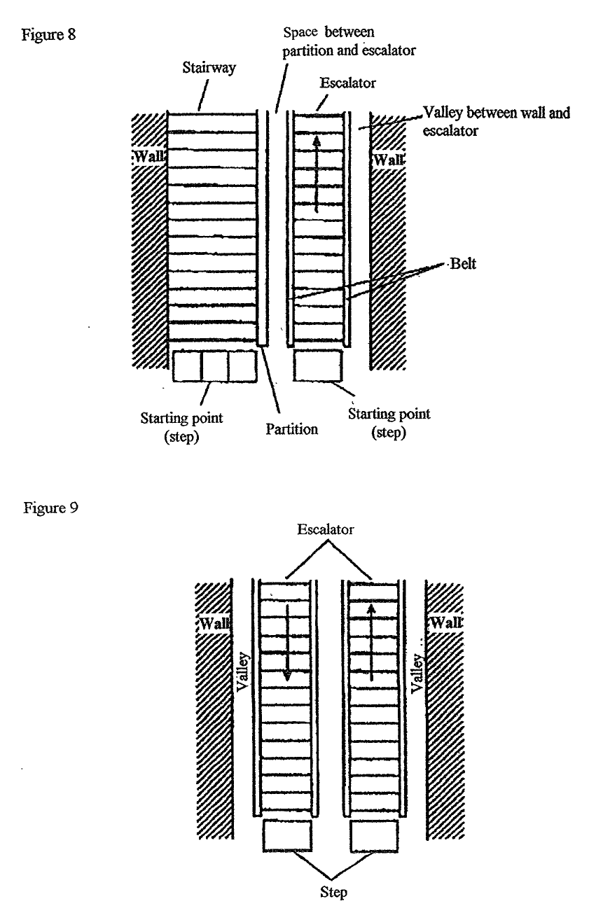

One way to make an advertisement effective is to post it at a location where it will be unavoidable by the user. The stairway and escalators connecting with the platform and walls of the platform are examples of locations the user is certain to pass through. The escalator and platform, among others, are where the user stops and finds nothing to look at. FIG. 8 shows a typical passage combining an escalator and stairway. The premises of a large subway station may have a passage consisting of up and down escalators only, as shown in FIG. 9. Advertisements would be posted not only on the obvious walls shown in the figure, but also in the valleys existing between an escalator and a wall or between escalators. The latter, especially, are conspicuous to the eyes, being part of a flowing movement, and therefore they make a convenient location for a story-like advertisement (for example, the history of a line of merchandise). Pedestrians watch their steps most carefully on the steps of an escalator and stairway, and advertisements to be posted here would be another important part of the design effort.

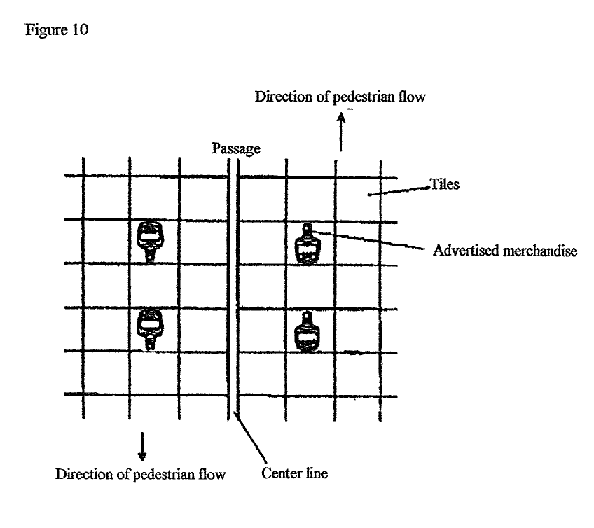

The objectives of designing the entire area of a subway station in the present invention include utility, in addition to interior beautification and business advertising. One utilitarian objective is to render advertised merchandise (obviously not limited to merchandise) function as a guide sign. For example, if the advertised product were a bottled health drink, turning the top of the bottle in the direction of foot traffic, as shown in FIG. 10, would indirectly show the direction to the pedestrian. An advertisement printed in light-storing pigment inks would give off the glow of those pigments and function as a guide sign for users in case of a power outage. An additional explanation of the light-storing pigment follows.

Illuminant comes in various natural luminescent materials such as fluorescent, phosphorescent and noctilucent. A material that has an especially long luminescence (afterglow) is referred to as a “light-storing” material. (The Ever-Bright brand has approximately 12 hours of afterglow.) More specifically, a light-storing pigment is a pigment that, upon excitation by light, such as sunlight, fluorescent light and others, converts its absorbed energy into visible light, continues to emit light for a period of time after the incidental light is removed, and has the ability to do so repeatedly for an extended period of time (10 years for a pigment). A light-storing pigment may be made into ink and used in screen-printing. The ink may be used in printing on various objects, fabrics, paper and others. Needless to say, a light-storing pigment may be mixed into a synthetic resin, or made into a paint, dye or powdered dye. The Ever-Bright T400 Series has the following features:

Its water-resistant property is ideal for use in a subway station that is subject to humidity and water leakage.

It is capable of emitting a variety of luminescent colors, including blue, bluish green, green, yellowish green, pink and colors previously unavailable (natural colors). The addition of coloring agents would degrade the weather resistance of conventional light-emitting pigments. By contrast, the T400 Series maintains weather resistance even after the coloring agents are added.

The material is pollution-free and nonradioactive, containing no nickel or other carcinogenic substances.

Its excitation wavelength is 250 and 700 mm, extending into the visible light range.

The inclusion of a light-storing pigment, such as the foregoing, in the printing of the advertisement under the present invention adds the ability to function as a guide sign in the dark in case of a power outage. The posting of an advertisement using light-storing pigments along the subway track in a tunnel would give an unconventional, novel effect as it stands out amid the light from a train. Especially, a range within approximately 100 meters of a station platform into a tunnel is where a train runs slowly, either decelerating or accelerating, thus enabling the passenger aboard the train to read the posted advertisement.

Most of the structures in a subway station are exposed, and that is one reason the subway premises look tasteless. For example, water leakage is left without a gutter, soiling the wall. Even if a gutter is provided, it is still exposed. In the present invention a functional as well as decorative design incorporating the structure shall be used. The gutter in the above-described case shall be decorated and expressed as an integral part of a larger picture. That is, the structure shall be rendered inconspicuous through the use of the so-called trompe 1'oeil approach, meaning a visual deception. A practical implementation shall be given in the examples.

### EXAMPLES

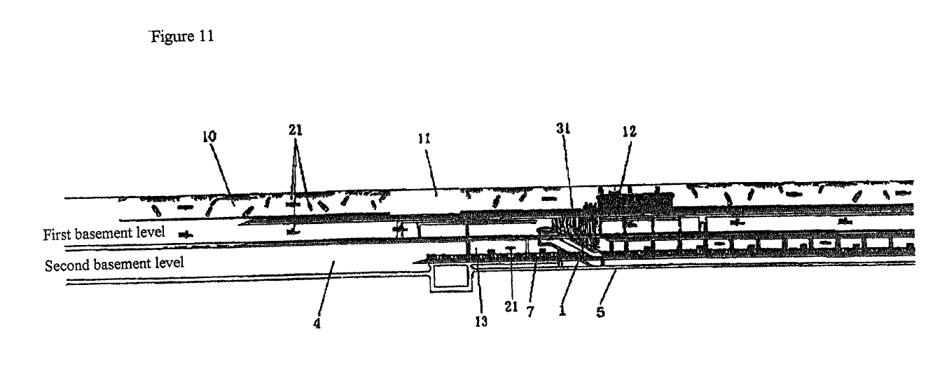

A number of different design examples shall be given. FIG. 11 shows a design applied to part of the left side of the subway station premises shown in FIG. 1(3). In that FIG. 10, 11, 12 and 13 are the designs used as backgrounds, applied to the entire walls, while 21 is the advertised merchandise, used as a foreground. Advertised merchandise 21 (including advertised lettering) may be in a pasted application over the background, or may be printed together with the background. For a case in which an advertisement may be changed in the near future (for example, in one or two years), the foreground may be a paste-on cutout. In this case, the foreground section (in a design block) shall use a removable adhesive.

Banner 31, draping from the ceiling of escalator 1, is past of the design. Banners shall carry advertisements, too. Advertisement 21 (which shall also be carried on banner 31) is printed in inks containing light-storing pigments, serving an additional function as guide marker in case of a power outage.

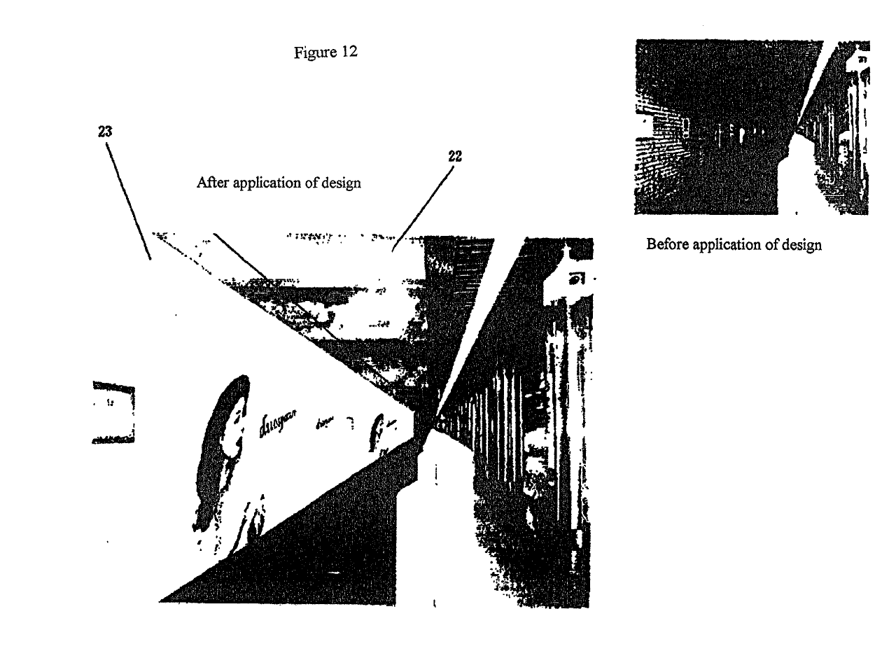

FIG. 12 shows an example of a design on the wall facing a subway platform and the ceiling over a track. Ceiling 22 over track 24 has skies, while wall 23 along the track has a person arranged on a monochrome background (white in this example). A comparison of the area before and after the application of the design obviously shows how much the design helps the platform area to be brighter and more open in its feeling.

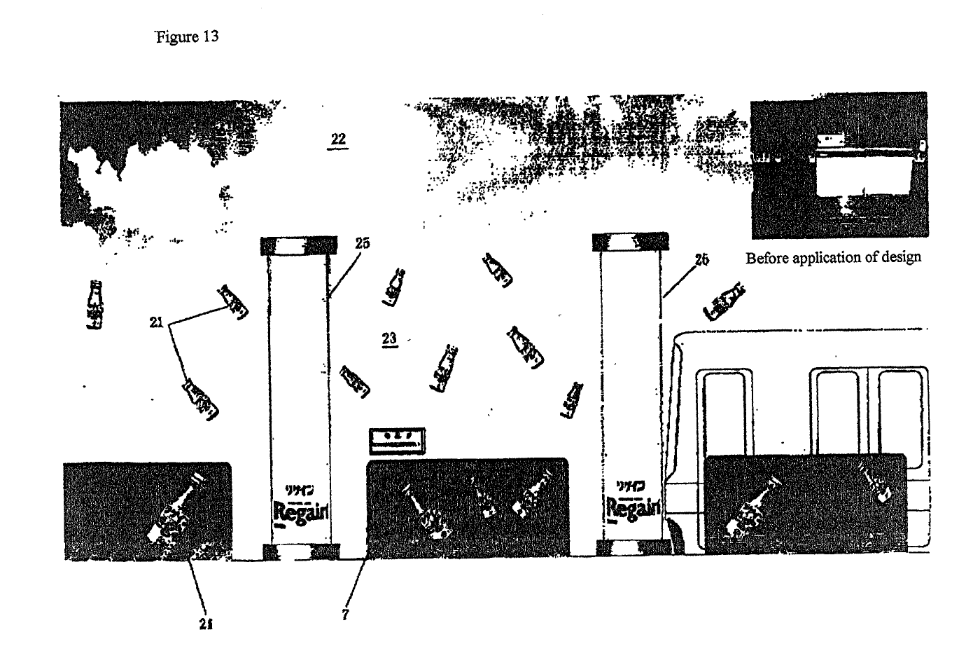

FIG. 13 shows the wall alongside the track and the wall above it, as seen from the same platform. The integrated drawing of wall 23 and ceiling 22 allows the representation of the closed-in section as a vast, open space. Picture 25 of a pillar drawn over wall 23 is a trompe l'oeil hiding a gutter.

The basis for the design under the present invention shall be the principle of one advertiser for the entire area of a subway station, thus permitting a unified design concept. The principle also allows advertisements to depart from the current spot- or merchandise-oriented formats and start publicizing a corporate image.

Contemporary subway station premises are dreary areas, largely because the structures are exposed, walls and ceilings are left as originally constructed, or soiled by water leakage. The primary concern of a subway system, be it owned by a municipality, political entity, governmental agency or private business, is service to the public. With most of its revenue dependent on passenger fares, subway operation is not necessarily affluent. The advertising throughout the premises of a subway station by one advertiser on the basis of a unified concept under the present invention makes it possible for the advertiser to expect a higher advertising effect, while the subway operator will have the station premises beautified using the revenues of that advertising. The focus of television commercials is often placed on publicizing a corporate image when an entire program is sponsored by one company. If the sponsored program is of good quality, the program itself will induce the viewer to picture a positive corporate image. In a similar manner, the design (not limited to merchandise advertisements but also extending to decoration of the entire premises as a background) rendered on a unified concept under the present invention contributes to improvements in the advertiser=3 s public image. The offering of a comfortable environment to subway users is another effect of the use of the present invention.

In designing under the present invention, prime consideration is given to the installation of the finished design in the form of wrapping sheets. This installation contributes to a faster installation, and it enables the design data to be printed out directly as prepared in a computer system. A savings is realized in the redesigning time where the changing or renewing of existing data (especially an existing advertisement) is accomplished through replacement of a small component in the data using a computer. Through the selection of appropriate adhesives for wrapping sheets, the use of a removable adhesive for frequently replaceable or renewable designs (primarily, advertisements) allows the simple re-pasting of the changed portion over the background (mounted using a strong adhesive type), thereby facilitating the constant renewal of merchandise advertising at a relatively small expense.

The main purpose of the present invention is to provide an efficient design method, beautify the premises of subway stations, offer users a comfortable space, and improve the advertising effect. The invention, however, is characterized by its utilitarian purpose. For example, the advertisement printed in light-storing pigment inks serves as a guide marker in case of a power outage.

The use of a wrapping sheet printed with light-storing pigment inks facilitates the placement of advertising within the tunnel itself, which has previously not been implemented. A new advertising effect can be expected from fascinating new expressions that stand out in the dark.

The computer graphics system of the present invention can be configured by combining existing hardware and software, making it economical and easy to use. For example, a Macintosh or Windows-compatible personal computers will suffice as a graphic design computer. A 3M Scotch 2000 Series printer can print wrapping sheets, and the PhotoShop and Illustrator software programs, which are popular in the field of computer graphics, are sufficiently adequate for the purposes. At any rate, the present invention is characterized by its ability to execute and manage the entire process, from design through printing and the management of installation, on a computer.

1. A computer system for designing on a unified concept an entire area of a subway station, including passages extending from a subway entrance connecting ground-level public streets to station platforms, said computer graphics system comprising the steps of:
designing an entire station, including walls, floors and ceilings of a passage, floors, valleys between escalators, walls, steps and ceilings of an escalator, walls of a platform, tunnels (portions extending about 100 meters into a tunnel from an end of a platform), pillars, floors and the like on a unified concept using computer graphics;
registering various created designs in a database as components; and
pasting said components together on a specified location as needed in order to design an entire area of a subway station.

2. A computer graphics system for designing an entire area of a subway station according to claim 1, wherein subway premises are divided into blocks of certain sizes for design purposes; and components that are design data including designs to be drawn on a wall of a certain area and the like, corresponding to said blocks, are printed on wrapping sheets with adhesives applied to back surfaces thereof for mounting on walls and floors of an area in any combination thereof; thereby incorporating a means to improve efficiency in transportation and installation work.

3. A design method in the computer graphics system according to claim 1, wherein background and foreground are separately designed; making a contract exclusively with a single advertiser (sponsor) for the entire area of a subway station; advertiser's merchandise are designed into components of the foreground; and the components, which are the foregrounds, are laid out on the background in a storytelling continuity, starting at an entrance and ending at station platforms, in accordance with a flow of passengers.

4. A computer graphics system for designing an entire area of a subway station according to claim 1, wherein in an event of a change in advertisers or of an advertised content, redesign is achieved efficiently by means of replacing advertising designs, which are said components, while leaving the background as is.

5. A method of decoration in the design method according to claim 3, wherein wrapping sheets with a strong adhesive are used for the background that remains the same for a long period of time; wrapping sheets with a removable adhesive are used for the foreground that has a high probability for replacement; and only foreground wrapping sheets are replaced upon a change in advertising content; thus ensuring a flexibility of construction work.

6. A method of designing advertisement in the computer graphics system according to claim 4, wherein advertisements, which use light-storing pigments, are posted on walls along an escalator, a space between the wall and a handrail belt of the escalator, a space between escalators, steps at entrance and exit of the escalator, and other areas around the escalator, thus simultaneously having an advertising effect and a traffic-guidance effect of a guide sign during normal times and during periods of power outage.

7. A method of designing advertisement in the computer graphics system according to claim 4, wherein advertisements, which are printed or painted in light-storing pigments, are posted in an area extending about 100 meters into a tunnel from an entrance thereof at an end of a platform or in a block within a tunnel, thus causing the advertisements to stand out in a dark through luminescence of said light-storing pigments.

8. A method of designing advertisement in the computer graphics system according to claim 4, wherein a gutter is installed on an underground wall in order to prevent soiling thereof by water leakage; and an entire area, including the gutter is designed as one picture in such a way that the gutter becomes inconspicuous.
